(19) United States
(12) Patent Application Publication
(10) Pub. No.: US 2012/0017394 A1
(43) Pub. Date: Jan. 26, 2012

(54) HANDLE HINGE

(75) Inventors: Richard A. Junk, Elkhorn, WI (US); Craig R. Butzlaff, Waukesha, WI (US)

(73) Assignee: Briggs & Stratton Corporation, Wauwatosa, WI (US)

(21) Appl. No.: 12/841,538

(22) Filed: Jul. 22, 2010

(51) Int. Cl. E05D 11/10; B23P 19/04

(52) U.S. Cl. 16/349; 29/428

(57) ABSTRACT

A handle hinge includes a first member; a second member is pivotably coupled to the first member; and a sleeve. One of the sleeve and the first member is movable between a first state in which the sleeve extends across a junction of the first member and the second member to inhibit pivoting of the first member and the second member, and a second state in which the sleeve and the first member are positioned to allow pivoting of the first member and the second member.

### BACKGROUND

Implements often include handles, allowing the implement to be manually pushed or pulled. Existing handles are expensive and not easily collapsed when the implement is no longer in use.

### BRIEF DESCRIPTION OF THE DRAWINGS

FIG. 1 is a perspective view of a foldable appliance in an extended state according to an example environment.

FIG. 2 is a perspective view of the foldable appliance in a folded state.

FIG. 3 is an enlarged fragmentary perspective view of a handle hinge of the foldable appliance of FIG. 1.

FIG. 4 is a sectional view of the handle hinge of FIG. 3.

FIG. 5 is an enlarged fragmentary perspective view of a handle hinge of the foldable appliance of FIG. 2.

FIG. 6 is a sectional view of the handle hinge of FIG. 5.

FIG. 7 is a front elevational view of another embodiment of the handle hinge of FIG. 3 in an extended and locked state.

FIG. 8 is a sectional view of the handle hinge of FIG. 7.

FIG. 9 is a front elevational view of the handle hinge of FIG. 7 in an extended and unlocked state.

FIG. 10 is a sectional view of the handle hinge of FIG. 9.

FIG. 11 is a front elevational view of the handle hinge of FIG. 7 in a folded state.

FIG. 12 is a sectional view of the handle hinge of FIG. 11.

### DETAILED DESCRIPTION OF THE EXAMPLE EMBODIMENTS

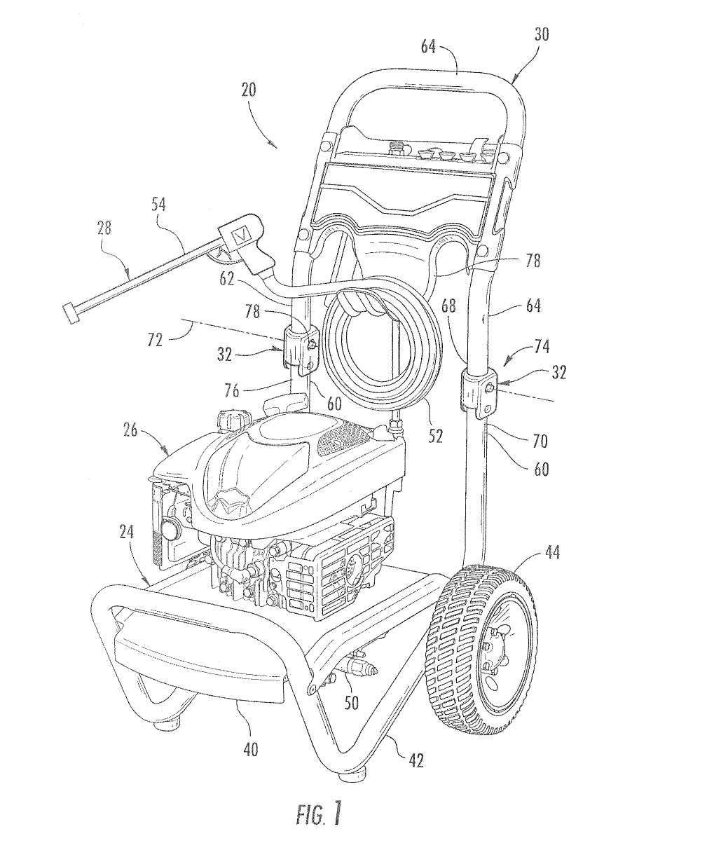

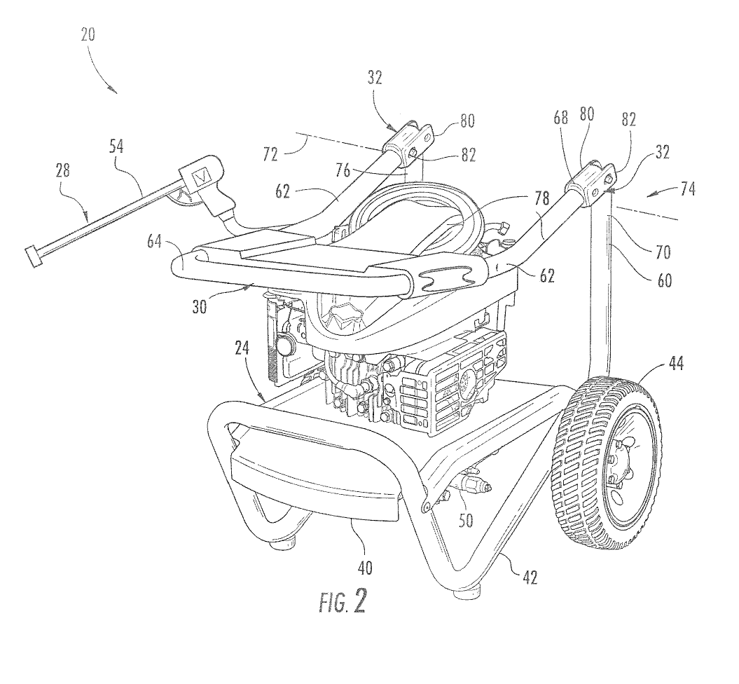

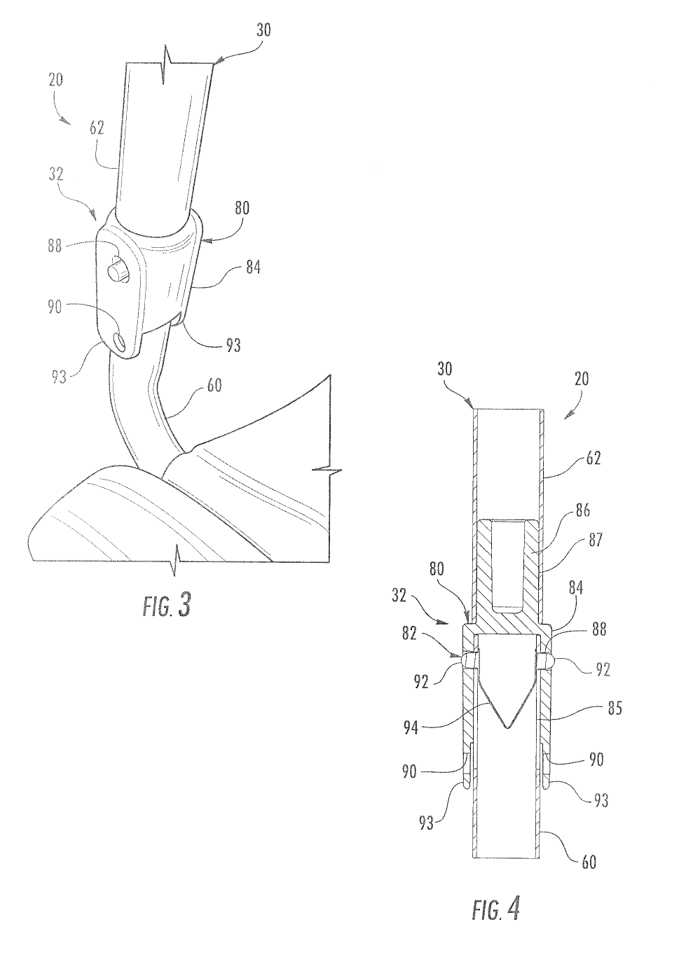

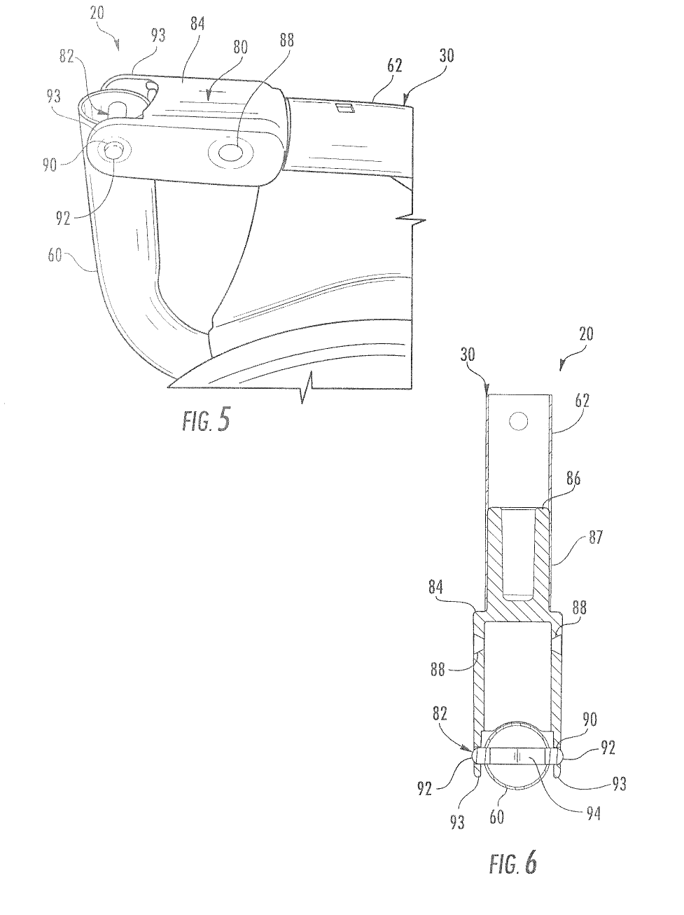

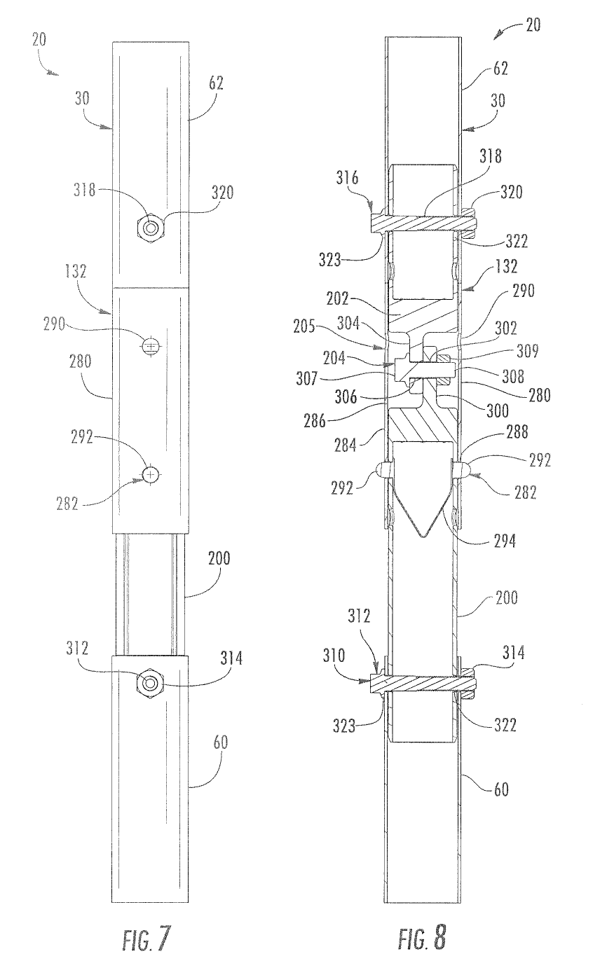

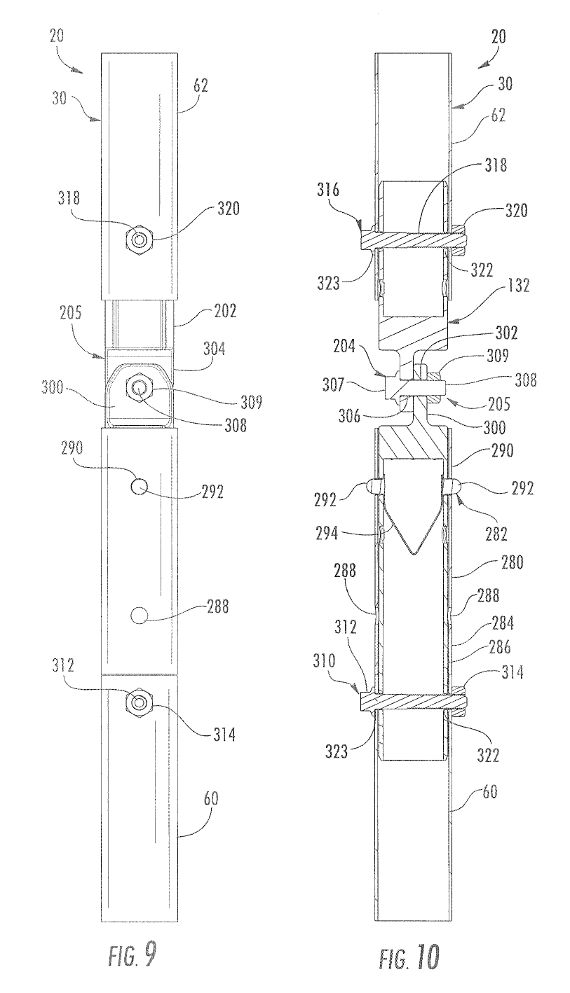

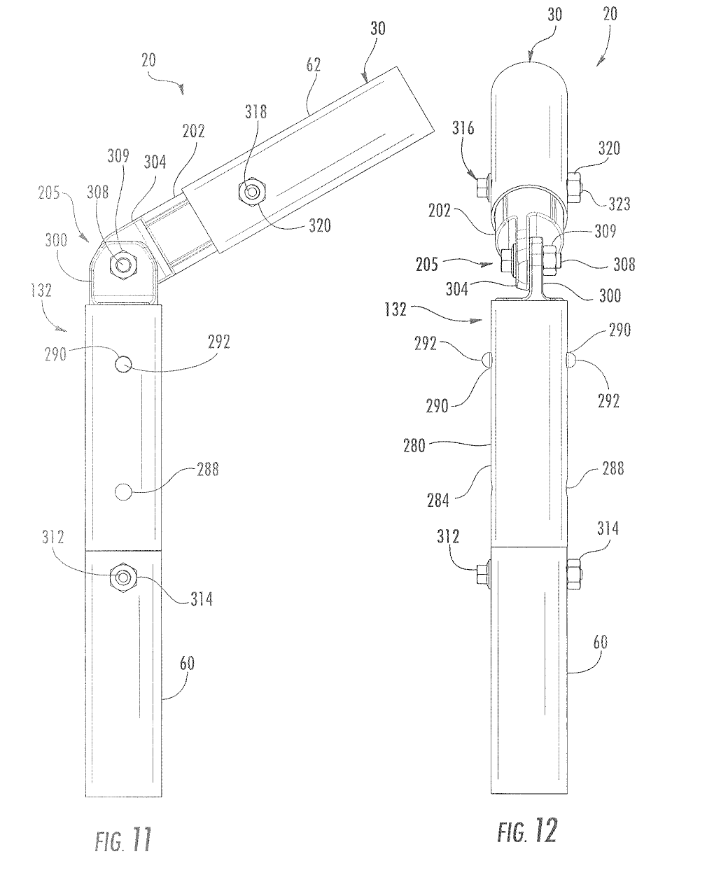

FIG. 1 illustrates a foldable appliance (shown as a fluid sprayer 20) according to an example embodiment. Fluid sprayer 20 delivers fluid under relatively high pressures. As will be described hereafter, fluid sprayer 20 includes a sleeve that either locks two portions of a handle together or allows the handle of the fluid sprayer 20 to be folded for compactness during transporting and storage of the fluid sprayer 20. The sleeve reliably secures and maintains the handle against pivoting or folding movement during use of fluid sprayer 20 and may be easily adjusted to allow collapsing of the handle.

Fluid sprayer 20 includes support 24, drive unit 26, working unit 28, handle 30 and handle hinge 32. Support 24 comprises one or more structures configured to serve as a foundation for supporting the remaining components of the foldable appliance (fluid sprayer 20). In the example illustrated, support 24 includes platform 40, frame 42 and wheels 44. Platform 40 comprises a base supporting drive unit 26 and working unit 28. In other embodiments, platform 40 may comprise a bracket, a frame or other structures.

Frame 42 comprises a series of beams, brackets or other structures extending between platform 40, wheels 44 and handle 30. In the example illustrated, frame 42 is integrally formed as part of a single unitary body with portions of handle 30. In other embodiments, frame 42 may alternatively be formed as part of single unitary body with platform 40. Although illustrated as being formed from a shaped tubular member, frame 42 may have other configurations.

Wheels 44 are rotationally coupled to frame 42 and assist in elevating portions of frame 42 and platform 40 above a supporting surface or ground. In the example illustrated, wheels 44 freely rotate or idle. In other embodiments, wheels 44 may be powered or driven by an engine or motor. Although fluid sprayer 20 is illustrated as including a pair of wheels 44 (one of which is shown), wherein a front end of frame 42 rests upon the ground or underlying surface, in other embodiments, fluid sprayer 20 may include three, four or additional wheels. In yet another embodiment, wheels 44 may be omitted or replaced with other ground motive mechanisms such as tracks, skis or the like. Although wheels 44 are illustrated as being rotationally coupled to frame 42, in other embodiments, wheels 44 may alternatively be operably coupled to platform 40 or to portions of drive unit 26 or working unit 28.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

Drive unit 26 comprises a unit or mechanism configured to provide or supply torque or other motive force to working unit 28. In the example illustrated, drive unit 26 comprises an internal combustion engine operably coupled to working unit 28 and supported by support 24. In other embodiments, drive unit 26 may alternatively comprise electrically powered motor. In the yet other embodiments, drive unit 26 may be omitted, such as where working unit 28 is manually powered.

Working unit 28 comprises one or more mechanisms configured to utilize the received torque or force to transform or work upon the surrounding environment or a medium. In the example illustrated, working unit 28 comprises fluid pump 50, hose 52 and spray gun 54. Fluid pump 50 is suspended below platform 40 and is configured to pressurize fluid, such as water. According to one embodiment, the pump serving as working unit 50 comprises a pump at least similar to the pump shown and described in U.S. Pat. No. 6,092,998 to Dexter et al. which issued on Jul. 25, 2000, the full disclosure of which is hereby incorporated by reference. Hose 52 is connected to fluid pump 50 and delivers pressurize fluid from fluid pump 52 spray gun 54. Spray gun 54 allows a person to selectively control and direct the emission of pressurized fluid.

In other embodiments, working unit 28 may comprise mechanisms configured to perform other functions. For example, in other embodiments, working unit 28 may comprise transmission and cutting blades of a lawnmower, trimmer or other cutting mechanism, the transmission and auger of a snow thrower or snow blower, the transmission and tines or blades of a tiller, the electrical power generating components of an electrical generator or other working mechanisms.

Handle 30 extends from support 24 and is configured to be manually grasped by a person using appliance 20, allowing the person to reposition and move appliance 20. Handle 30 includes lower beams 60, upper beams of 62 and cross member 64. Lower beams 60 form a lower portion of handle 30 and extend upwardly from support 24 on opposite transverse sides of appliance 20. In the example illustrated, lower beams 60 are integrally formed as part of a single unitary body with the tubular members of frame 42. In other embodiments, lower beams 60 may alternatively be joined to frame 42 or to platform 40 directly or indirectly in other manners. In the example illustrated, lower beams 60 comprise tubular members. In other embodiments, lower beams 60 may alternatively have other cross-sectional shapes. Lower beams 60 are coupled to upper beams 62.

Upper beams 62 and cross member 64 form an upper portion of handle 30. Upper beams 62 are hinged or pivotally coupled to lower beams 60 by handle hinge 32 for pivotal movement about pivot axis 72.

Cross member 64 comprises a member extending between and interconnecting upper beams 62. Cross member 64 cooperates with upper beams 64 to form a U-shaped handle. In the example illustrated, cross member 64 comprises tubular member integrally formed as part of a single unitary body with both of upper beams 62. In other embodiments, cross member 64 may comprise separate member fastened, welded or connected to upper beams 62.

As further shown by FIG. 1, handle 30 may additionally be used to support and carry additional structures such as the hose hook 78 shown. In yet other embodiments, handle 30 may be utilized to support controls for one or both of drive unit 26 or working unit 28. Although handle 30 is illustrated as being substantially an inverted U, in other embodiments, handle 30 may have other configurations wherein handle 30 is configured to be folded from an extended use state (shown in FIG. 1) to a collapsed or folded state.

Handle hinges 32 comprise mechanisms configured to be actuated to one of two different states: a first state inhibit pivoting or folding of the upper portion of handle 30 relative to the lower portion of handle 30 and a second state allowing pivoting or folding of the upper portion of handle 30 relative to the lower portion of handle 30. FIG. 2 illustrates upper beam 62 of handle 30 pivoted or folded relative to lower beams 60 of handle 30, allowing handle 30 to be folded for compactness during transporting and storage of the fluid sprayer 20. In the example illustrated, handle 30 collapses or folds in a forward direction so as to overly or overlap platform 40. In other embodiments, handle 30 may additionally or alternatively collapse or fold in a rearward direction to also reduce a height of fluid sprayer 20.

FIGS. 3-6 illustrate handle hinges 32 in more detail. FIGS. 3 and 4 illustrate one of handle hinges 32 in a handle extended or locking position or state in which handle 30 is extended for use of fluid sprayer 20. FIGS. 5 and 6 illustrate one of handle hinges 32 in a collapsing, unlocking or released position or state in which handle 32 is allowed to pivot or collapse. As shown by FIGS. 3 and 4, each handle hinge 32 comprises a sleeve 80 and pivot shaft-retainer 82. Sleeve 80 comprises a structure 84 coupled to the upper portion of handle 30 while being configured to guide movement of the lower portion of handle 30. In the example illustrated, sleeve 80 has an interior 85 that is configured (shaped and dimensioned) to slidably receive and guide linear movement of the lower portion of handle 30.

In the example illustrated, sleeve 80 comprises the tubular structure having a stem 86 that is press fit into a hollow interior 87 of a corresponding tubular structure forming an end of upper beam 62 of the handle 30. In other embodiments, sleeve 80 may be coupled (directly or indirectly) to the upper beam 62 of the handle 30 in other manners. For example, sleeve 80 may be welded, fastened, bonded, releasably or resiliently snapped into or onto, or integrally formed as part of a single unitary body with the upper beam 62 of the handle 30.

As further shown by FIGS. 3-6, sleeve 80 includes a pair of longitudinally or axially spaced detents: locking detents 88 and pivot detents 90. Locking detents 88 comprise openings, indents, depressions or other cavities in structure 84 of sleeve 80 that are configured to receive portions of pivot shaft retainer 82 when sleeve 80 and beam 62 of handle 30 are positioned such that sleeve 80 extends across a junction of upper beam 62 and lower beam 60 (two members) such that sleeve 80 contacts portions of beam 60 and abuts beam 60 in directions non-parallel to a pivot axis of handle 30 so as to inhibit pivoting of beams 60 and 62 relative to one another. In the example illustrated, sleeve 80 and beam 62 of handle 30 are positioned such that interior 87 receives one of lower beams 60 to inhibit collapsing or folding of handle 30. In the example illustrated, locking detents 88 comprise apertures completely extending through structure 84. In other embodiments, locking detents 88 may comprise depressions partially extending into structure 84 or bent or deformed walls or portions of structure 84. Locking detents 88 assists and retaining sleeve 88 in the position in which it inhibits folding or collapsing of handle 30. Locking detents 88 further provide a person with a positive feel or or indication of when handle 30 and sleeve 80 are in the first state in which the folding of handle 30 is inhibited.

Pivot detents 90 comprise openings, indents, depressions or other cavities in ears 93 of structure 84 of sleeve 80 that are configured to receive portions of pivot shaft retainer 82 when sleeve 80 and the upper portion of handle 30 are in the second state and or positioned such that sleeve 80 does not extend across a junction of one of upper beams 62 and lower beams 60 and such that interior 86 does not receive one of lower beams 60 to allow pivoting of upper beams 62 relative to lower beams 60 for collapsing or folding of handle 30. Pivot detents 90 are provided along the sleeve 80 between locking detents 88 and an end of sleeve 80 closest to lower beams 60.

In the example illustrated, pivot detents 90 comprise apertures completely extending through structure 84. In other embodiments, pivot detents 90 may comprise depressions partially extending into structure 84 or bent or deformed walls or portions of structure 84. Pivot detents 90 at least partially receive portions of pivot shaft retainer 82 to pivotally connect sleeve 80 to upper beams 62. Pivot detents 90 further provide a person with a positive feel or indication of when handle 30 and sleeve 80 are in the second state in which the folding of handle 30 is facilitated.

Pivot shaft-retainers 82 each comprise a pair of oppositely extending shafts or pins 92 carried by each of lower beams 60 of handle 30. Pins 92 are resiliently biased outwardly, away from one another, by a spring 94. Pins 92 are resiliently biased by spring 94 so as to project outwardly beyond lower beams 60 into reception within either locking detents 88 as shown in FIG. 3 or pivot detents 90 as shown in FIG. 5 depending upon the positioning of sleeve 80 and upper beams 62. In the example illustrated, pins 92 are resiliently biased to completely project through the apertures forming detents 88, 90. When pins 92 are received by detents 90, pins 92 to serve as axles and form pivot axes about which upper beams 62 of handle 30 rotate or pivot when handle 30 is being folded or collapsed or when handle 30 is being moved from a collapsed state to an extended, upright state. Pins 92 are further configured such that pins 92 may be manually squeezed or pushed inwards towards one another against the bias of spring 94 to a position withdrawn from detents 88, 90, allowing sleeve 88 and upper beams 62 to be moved relative to lower beams 62. Although spring 94 is illustrated as a leaf spring integrally formed as a single unitary body with pins 92, in other embodiments, spring 94 may be separate from pins 92 and may be another type of spring, such as a compression spring.

In operation, handle hinges 32 provide a simple, yet artful mechanism by which handle 30 may be retained in an extended, upright and in-use position and by which handle 30 may be easily collapsed and folded for transport or storage. When foldable appliance 20 is being used, pins 92 are received by locking detents 88, securing and retaining handle 30 in an upright position. When foldable appliance is no longer to be used and is to be stored or transported, a person merely needs to depress pins 92 against the bias of spring 94 to withdraw pins 92 from locking detents 88. Thereafter, the person merely needs to lift upper beams 64 to move the sleeves 80 upward until pins 92 are automatically resiliently biased into reception in pivot detents 90, allowing handle 30 to be collapsed or folded. To once again use appliance 20, the person first rotates handle 30 about the axis of pins 92 to an upright position. To secure handle 30 in the upright position, the person depresses pins 92 against the spring 94 and pushes handle 32 downward, causing sleeve 80 to receive a greater extent or portion of lower beams 60 such that sleeve 80 extends across a junction of lower beams 60 and upper beams 62, inhibiting pivoting or folding of handle 30.

Although handle hinges 32 are illustrated as having sleeves 80 connected to and carried by upper beams 62 while either receiving lower beams 60 (when in a first locked state) or pivotally connected to lower beams 60 (when in a second pivoting state), in other embodiments, this relationship may be reversed. For example, sleeves 80 may alternatively be connected to and carried by lower beams 60 while either receiving upper beams 62 (when in a first locked state) or pivotally connected to upper beams 62 (when in a second pivoting state). Although sleeves 80 are illustrated as including detents 88, 90 while pivot shaft retainers 82 are carried by lower beams 60, this relationship may be reversed. For example, sleeves 80 may alternatively carry pivot shaft retainers 82 while lower being 60 include detents 88, 90. Although pins 92 are illustrated as being resiliently biased outwardly for reception by detents 88, 90, in other embodiments, pins 92 may alternatively be resilient biased inwardly (towards one another) for reception by detents 88, 90. Although sleeves 80 are illustrated as receiving portions of lower beams 60 when in the first locked state, in other embodiments, sleeves 80 may alternatively comprise plugs or extensions projecting into and received by hollow interiors or cavities of lower beams 60 to thereby extend across a junction of lower beams 60 and upper beams 62 (first and second members) when in the locked state.

FIGS. 7-12 illustrate handle hinge 132, another embodiment of handle hinge 32. Handle hinge 132 may be incorporated as part of appliance 20 in place of handle hinge 32. As with handle hinge 32, handle hinge 132 is configured to be actuated between two states: a first locking state inhibit pivoting or folding of upper beams 62 of handle 30 relative to lower beams 60 of handle 30 and a second pivoting state allowing pivoting or folding of the upper beams 62 of handle 30 relative to the lower beams 60 of handle 30. FIGS. 7 and 8 illustrate handle hinge 132 in the first locking state. FIGS. 9 and 10 illustrate handle hinge 132 in an unlocked state prior to handle 30 being pivoted or collapsed. FIGS. 11 and 12 illustrate handle hinge 132 in an unlocked state after pivoting or folding of handle 30.

Handle hinge 132 comprises lower hinge extension 200, upper hinge extension 202, pivot shaft 204, sleeve 280 and retainer 282. Lower hinge extension 200 extends from a lower beam 60 and includes an upwardly projecting ear 300 having an aperture 302. Similarly, upper hinge extension 202 extends from an upper beam 62 and includes a downwardly projecting ear 304 having an aperture 306. Pivot shaft 204 comprise a shaft extending through apertures 288 and 292 so as to serve as an axle or hinge about which upper hand extension 202 may pivot. In the example illustrated, pivot shaft 204 comprises a bolt having a head 307 at one end and a threaded end 308 fastened to a nut 309 to retain shaft 204 in place. Extensions 200, 202 (two members) and pivot shaft 204 form a pivot joint 205 to pivotally connect or hinge lower beams 60 to upper beams 62 of handle 30. In other embodiment, other mechanisms may be used to pivotally connect or hinge lower beams 60 to upper beams 62 of handle 30. In such alternative embodiments, such alternative hinging mechanisms are sized so as to be receivable within sleeve 280.

In the example illustrated, lower hinge extension 200 is secured to lower beam 60 by a fastener 310 comprising a bolt 312 and a nut 314. Likewise, upper hinge extension 202 is secured to upper beam 62 by a fastener 316 comprising a bolt 318 and a nut 320. Such bolts 312, 318 extend through aligned apertures 322, 323 within extensions 200, 202 and beams 60, 62, respectively. In other embodiments, extensions 200, 202 may be secured to or coupled to beams 60 and 62, respectively, in other manners. For example, extensions 200, 202 may alternatively be welded, bonded, press fit into or onto, snapped into or onto or integrally formed as part of a single unitary body with beams 60 and 62, respectively.

Sleeve 280 comprises a structure 284 coupled to the upper portion of handle 30 while being configured to guide movement of the lower portion of handle 30. In the example illustrated, sleeve 280 has an interior 286 that is configured (shaped and dimensioned) to be linearly slidable between a locked state or position shown in FIGS. 7 and 8 and a withdrawn and unlocked state or position shown in FIG. 12. In the locked state, sleeve 280 concurrently extends over and across at least portions of both extension 200 and 202 such that sleeve 280 extends across or overlaps a junction of extensions 200, 202 to inhibit pivoting of beams 60 and 62 relative to one another. In the withdrawn and unlocked state, sleeve 280 is withdrawn from the junction of beams 60, 62, allowing beams 60 and 62 to pivot or fold relative to one another.

Similar to sleeve 80, sleeve 280 includes a pair of longitudinally or axially spaced detents: locking detents 288 and pivot detents 290. Locking detents 288 comprise openings, indents, depressions or other cavities in structure 284 of sleeve 280 that are configured to receive portions of pivot shaft retainer 282 when sleeve 280 is positioned such that sleeve 280 extends across a junction of upper beams 62 and lower beams 60 and such that interior 286 receives one of lower beams 60 to inhibit collapsing or folding of handle 30. In the example illustrated, locking detents 288 comprise apertures completely extending through structure 84. In other embodiments, locking detents 288 may comprise depressions partially extending into sleeve 280 or bent or deformed walls or portions of sleeve 280. Locking detents 288 are provided along the sleeve 280 between pivot detents 288 and an end of sleeve 280 closest to lower beams 260. Locking detents 288 assist in retaining sleeve 280 in the position in which it inhibits folding or collapsing of handle 30. Locking detents 288 further provide a person with a positive feel or indication of when sleeve 280 is in the first state in which the folding of handle 30 is inhibited.

Pivot detents 290 comprise openings, indents, depressions or other cavities in sleeve 280 that are configured to receive portions of pivot shaft retainer 282 when sleeve 280 is in the second state and is positioned such that sleeve 280 does not extend across a junction of upper beams 62 and lower beams 60 and such that interior 286 does not receive lower beam 60 to allow pivoting of upper beams 62 relative to lower beams 60 for collapsing or folding of handle 30.

In the example illustrated, pivot detents 90 comprise apertures completely extending through sleeve 280. In other embodiments, pivot detents 290 may comprise depressions partially extending into sleeve 280 or bent or deformed walls or portions of a wall or interior of sleeve 280. Pivot detents 290 at least partially receive portions of retainer 282 to retain sleeve 280 in the withdrawn or handle pivoting position. Pivot detents 290 further provide a person with a positive feel or indication of when handle 30 and sleeve 280 are in the second state in which the folding of handle 30 is facilitated.

Retainers 282 each comprise a pair of oppositely extending shafts or pins 292 carried by each of lower beams 60 of handle 30. Pins 292 are resiliently biased outwardly, away from one another, by a spring 94. Pins 292 are resiliently biased by spring 294 so as to project outwardly beyond lower beams 60 into reception within either locking detents 288 as shown in FIG. 8 or pivot detents 290 as shown in FIG. 10 depending upon the positioning of sleeve 280. In the example illustrated, pins 292 are resiliently biased to completely project through the apertures forming detents 288, 290. Pins 292 are configured such that pins 292 may be manually squeezed or pushed inwards towards one another against the bias of spring 294 to a position withdrawn from detents 288, 290, allowing sleeve 288 to be moved relative to beams 60, 62.

In operation, handle hinges 132 provide a simple, yet artful mechanism by which handle 30 may be retained in an extended, upright and in-use position and by which handle 30 may be easily collapsed and folded for transport or storage. When foldable appliance 20 is being used, pins 292 are received by locking detents 288, securing and retaining handle 30 in an upright position. When foldable appliance is no longer to be used and is to be stored or transported, a person merely needs to depress pins 292 against the bias of spring 294 to withdraw pins 292 from locking detents 288. Thereafter, a person merely needs to lower sleeves 280 to move the sleeves 280 downward until pins 292 are automatically resiliently biased into reception in pivot detents 290, allowing handle 30 to be collapsed or folded. To once again use appliance 20, the person first rotates handle 30 to an upright position. To secure handle 30 in the upright position, the person depresses pins 292 against the spring 294 and lifts sleeve 280 until sleeve 280 extends across a junction of lower beams 60 and upper beams 62, inhibiting pivoting or folding of handle 30.

Although retainers 282 are illustrated as being connected to and carried by lower beams 62, in other embodiments, this relationship may be reversed. For example, retainers 282 may alternatively be connected to and carried by upper beams 62. Although sleeves 280 are illustrated as including detents 288, 290 sleeves 280 may alternatively carry retainers 82 while one or both of beams 60, 62 include one or both of detents 288, 290. Although pins 292 are illustrated as being resiliently biased outwardly for reception by detents 288, 290, in other embodiments, pins 292 may alternatively be resilient biased inwardly (towards one another) for reception by detents 288, 290.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A handle hinge comprising:
a first member;
a second member is pivotably coupled to the first member; and
a sleeve, wherein one of the sleeve and the first member is movable between a first state in which the sleeve inhibits pivoting of the first member and the second member, and a second state in which the sleeve and the first member are positioned to allow pivoting of the first member and the second member.

2. The handle hinge of claim 1, wherein the sleeve slides along and relative to the first member and the second member between the first state and the second state.

3. The handle hinge of claim 2, wherein the first member in the second member remain pivotably coupled to one another during sliding of the sleeve.

4. The handle hinge of claim 2 further comprising a pivot joint pivotably coupling the first member and the second member, wherein the sleeve receives the pivot joint when in the first state.

5. The handle hinge of claim 2 further comprising a locking mechanism configured to selectively retain the sleeve in the first state.

6. The handle hinge of claim 5, wherein the locking mechanism comprises:
a detent in one of the sleeve and one of the first member and the second member; and
a projection extending from the other of the sleeve and said one of the first member and the second member, wherein one of the projection and the detent is resiliently urged into retaining engagement with the other of the projection and the detent when in a locked state.

7. The handle hinge of claim 6, wherein the detent comprises a first opening through the sleeve.

8. The handle hinge of claim 7 further comprising a second opening through the sleeve, wherein the second opening is configured to receive the projection in the second state.

9. The handle hinge of claim 5, wherein the locking mechanism is configured to retain the sleeve in the second state.

10. The handle hinge of claim 1 further comprising a locking mechanism configured to selectively retain the sleeve and the first member in the first state.

11. The handle hinge of claim 1, wherein the sleeve and the second member are immovable relative to one another and wherein the first member is slidable relative to the second member and the sleeve between the first state and the second state.

12. The handle hinge of claim 11, wherein the sleeve axially receives the first member and when the first member is axially movable relative to the sleeve.

13. The handle hinge of claim 12 further comprising a locking mechanism configured to selectively retain the sleeve and the first member in the first state.

14. The handle hinge of claim 13, wherein the locking mechanism comprises:
a detent in one of the sleeve and one of the first member and the second member; and
a projection extending from the other of the sleeve and said one of the first member and the second member, wherein one of the projection and the detent is resiliently urged into retaining engagement with the other of the projection and the detent when in a locked state.

15. The handle hinge of claim 14, wherein the detent comprises a first opening through the sleeve.

16. The handle hinge of claim 15 further comprising a second opening through the sleeve, wherein the second opening is configured to receive the projection in the second state.

17. The handle hand of claim 16, wherein the first member carries the projection and wherein the projection forms a pivot axis about which the first member and the second member pivot when in the second state.

18. A method comprising:
pivotably connecting a first member and a second member of a handle; and
moving one of a sleeve and the first member between a first state in which the sleeve inhibits pivoting of the first member and the second member, and a second state in which the first member and the sleeve are positioned to allow pivoting of the first member and the second member.

19. The method of claim 18 further comprising sliding the sleeve relative to the first member and the second member between the first state and the second state.

20. The method of claim 18 further comprising sliding the first member axially relative to the sleeve and the second member between the first state and the second state.
